(19) United States
(12) Patent Application Publication
(10) Pub. No.: US 2011/0137538 A1
(43) Pub. Date: Jun. 9, 2011

(54) METHOD FOR DETERMINE GAS PRESSURE IN AN EXHAUST AFTER-TREATMENT SYSTEM

(75) Inventor: Igor ZANETTI, Verrayes (IT)

(73) Assignee: GM GLOBAL TECHNOLOGY OPERATIONS LLC, Detroit, MI (US)

(21) Appl. No.: 12/963,599

(22) Filed: Dec. 8, 2010

(30) Foreign Application Priority Data
Dec. 9, 2009 (GB) 0921538.5

(51) Int. Cl. F02D 28/00; G01M 15/10; G06F 19/00

(52) U.S. Cl. 701/102; 73/114.76; 702/50

(57) ABSTRACT

A method, a computer readable medium embodying a computer program product, and an apparatus are provided determining a pressure in an exhaust line of an internal combustion engine. The internal combustion engine has at least a combustion chamber with an associated exhaust line including, but not limited to a muffler and an after-treatment system. The after-treatment includes, but is not limited to units that are serially connected for at least reducing and preferably substantially eliminating emissions due to combustion products. The method includes, but is not limited to determining the pressure value upstream the muffler, and determining the pressure value upstream each unit of the after-treatment exhaust system by means of the equation Pᵢ₌Pᵢ₋₁+ΔPᵢ, where Pᵢ₋₁ is the value of the pressure downstream the unit i and ΔPᵢ is the drop of the pressure across the unit i.

### CROSS-REFERENCE TO RELATED APPLICATION

This application claims priority to British Patent Application No. 0921538.5, filed Dec. 9, 2009, which is incorporated herein by reference in its entirety.

### TECHNICAL FIELD

The technical field relates to a method for determining a pressure value in an exhaust line comprising an exhaust after-treatment system for reducing release in the environment of polluting emissions.

### BACKGROUND

Modern internal combustion engines, such as diesel engines, are provided with after-treatment exhaust system for reducing polluting emissions due to combustion products. The exhaust after-treatment systems are located between the engine and the muffler in a exhaust line and comprise a plurality of units, serial connected, as for instance a DOC (Diesel Oxidation Catalyst) unit, a DPF (Diesel particulate Filter) unit and an SCR unit (Selected catalyst reduction).

For a correct operation of the engine and for complying with the environment regulation on polluting emissions, it is indispensable to determine or estimate the value of the exhaust pressure upstream each unit. However the presence of a plurality of devices in the after-treatment system makes it complicated to estimate the value of the pressure upstream each device, because each unit of the exhaust after-treatment system causes a different drop of the exhaust pressure. Accordingly, the known exhaust after-treatment systems use a number of pressure sensors equal to the number of units, said pressure sensors being located upstream each unit. The presence of a plurality of pressure sensors increases the cost of the exhaust after-treatment system and it renders complicated the hardware and the control software for the data elaboration.

In view of the foregoing, at least one object is to minimize the number of pressure sensors or to eliminate the pressure sensors in the after-treatment system. Another object of the invention is to meet the goal with a simple, rational and inexpensive solution. In addition, objects desirable features and characteristics will become apparent from the subsequent summary and detailed description, and the appended claims, taken in conjunction with the accompanying drawings and this background.

### SUMMARY

An embodiment provides for a method for determining a pressure in an exhaust line, associated to an internal combustion engine, and which comprises a muffler and an after-treatment system, wherein the after-treatment comprises a plurality of units, serial connected, for reducing or eliminating polluting emissions due to combustion products.

According to the embodiment, the method comprises at least the following steps determining the pressure value upstream the muffler, determining the pressure value upstream each unit of the after-treatment exhaust system by means of the following equation:

Pᵢ₌Pᵢ₋₁+ΔPᵢ

Where Pᵢ₋₁ is the value of the pressure downstream the unit i and ΔPᵢ is the drop of the pressure across the unit i.

The step of determining the pressure value upstream the muffler preferably provides to measure the value of the environment pressure and to create a map representative of the drop pressure across the muffler in function of the temperature and of the exhaust gas mass flow, and to calculate the pressure value upstream the muffler by adding the measured environment pressure to the drop pressure across the muffler. The environment pressure can be calculated by means of a pressure sensor already associated to the engine, as for instance the pressure sensor associated to the mass flow sensor of the engine.

The drop of the pressure ΔPᵢ, across the unit i, is calculated by means of the following equation:

ΔPᵢ=k₁ᵢ·μᵢ·Qᵢ+k₂ᵢ·ρᵢ·Qᵢ²

Where k₁ᵢ and k₂ᵢ are constant, Qᵢ is the gas flow rate, ρᵢ represent the gas density, and μᵢ is the dynamic viscosity of the gas.

According to an embodiment, the gas flow rate is calculated by means of the following equation:

$$Qi = \frac{{\dot{m}}_{AIR} + {\dot{m}}_{ECU}}{{ρ}_{i}}$$

Where \dot{m}_{AIR} is the derivate in the time of the air flow rate aspirated from the engine and \dot{m}_{ECU} is the derivate in the time of the quantity of fuel injected calculated by the ECU, while the gas density ρᵢ is preferably calculated by means of the equation:

$${ρ}_{i} = \frac{{P}_{i - 1}}{{R}_{EG} \cdot {T}_{i - 1}}$$

where R_{EG} is the universal gas constant and Tᵢ₋₁ is the exhaust gas temperature downstream the unit i.

Preferably, the dynamic viscosity of the gas μᵢ is calculated by means of the equation:

$${μ}_{i} = {μ}_{i} ( T ) = {μ}_{o} \cdot \frac{{T}_{0} + C}{{T}_{i - 1} + C} \cdot {( \frac{{T}_{i - 1}}{{T}_{0}} )}^{\frac{3}{2}}$$

Where C is Sutherland's constant for the exhaust gas in question and μ₀ is the reference viscosity at the temperature T₀, and Tᵢ₋₁ is the exhaust gas temperature downstream the unit i.

According to an embodiment, if the exhaust after-treatment system comprises a DPF unit the drop pressure across the DPF is measured since an estimation of the drop of pressure across the DPF it's not trustworthy. The measure of the drop of pressure value across the DPF unit can be realized by means of a usual differential pressure sensor. From the above disclosure, numerous advantages are evident, including, but not limited to, only if the exhaust after-treatment system comprises a DPF unit, it is necessary a differential pressure sensor.

The method according to the embodiment can be realized in the form of a computer program comprising a program-code to carry out all the steps of the method and in the form of a computer program product comprising means for executing the computer program. The computer program product comprises, according to a preferred embodiment, a control apparatus for an IC engine, for example the ECU of the engine, in which the program is stored so that the control apparatus is adapted to perform the method. In this case, when the control apparatus execute the computer program the steps of the method are carried out.

The method according to the embodiment can be also realized in the form of an electromagnetic signal. The signal being modulated to carry a sequence of data bits which represent a computer program to carry out all steps of the method.

### BRIEF DESCRIPTION OF THE DRAWINGS

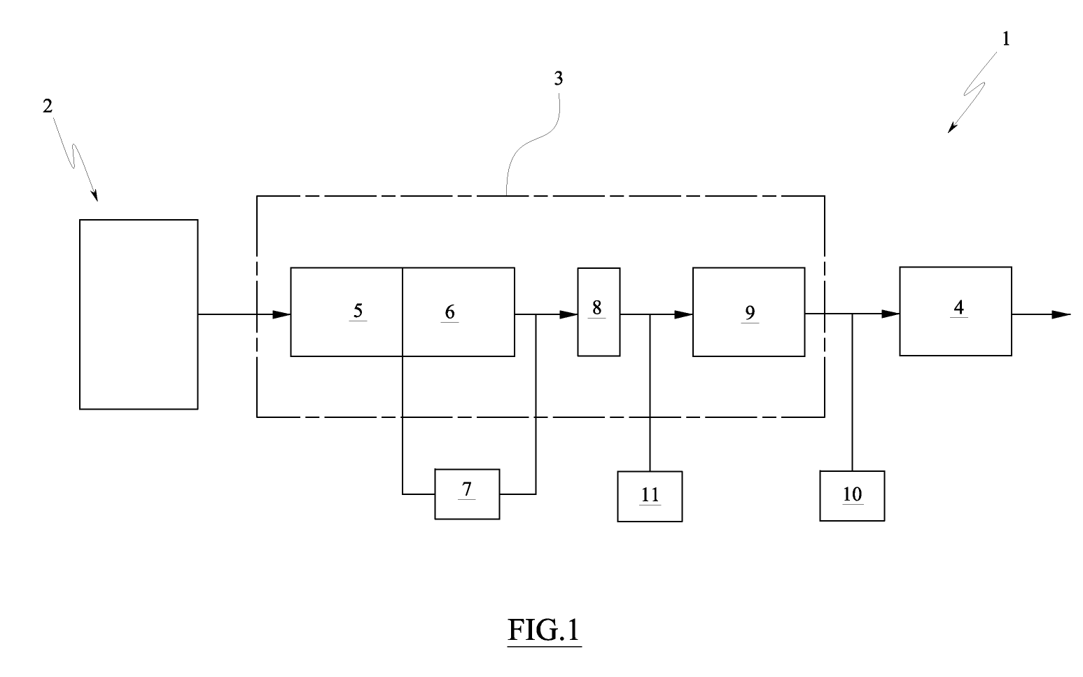

The present invention will hereinafter be described in conjunction with the following drawing FIG. 1, which a schematic illustration of an exhaust line of a Diesel engine according to an embodiment.

### DETAILED DESCRIPTION

The following detailed description is merely exemplary in nature and is not intended to limit application and uses. Furthermore, there is no intention to be bound by any theory presented in the preceding background or summary or the following detailed description.

FIG. 1 shows a schematic view of an embodiment of an exhaust line 1 associated to a Diesel engine 2, and which comprises an engine exhaust after-treatment system 3 and a muffler 4. The after-treatment system 3 comprises a plurality of units, coupled in flow series, for receiving and treating the exhaust gas, flowing from the engine 2, before to release it to the atmosphere.

In detail, the exhaust after-treatment system 3, disclosed in the embodiment comprises a Diesel oxidation catalyst (DOC) unit 5, which is connected to a Diesel particulate filter (DPF) unit 6. A differential pressure sensor 7 is associated to the Diesel particulate filter (DPF) unit 6 in order to measure the drop of pressure upstream and downstream the Diesel particulate filter (DPF). Downstream the Diesel particulate filter (DPF) 6, the after-treatment system 3 comprises a mixer unit 8 which has the function of mixing the exhaust gas with urea, injected by a known urea injector, not shown, to reduce emissions. The mixer unit 8 is flow connected with a selected catalyst reduction (SCR) unit 9, which is in turn connected with the muffler 4 of the exhaust line 1. The after-treatment system 3 comprises also two NOₓ sensor 10 and 11, respectively placed downstream the muffler and upstream the mixer unit 8.

The present invention allows estimating the pressure upstream each device of the after-treatment system 10 starting from the muffler. In order to determine the exhaust gas pressure value upstream the muffler 4 the method provides to measure the environment pressure value by means of a pressure sensor and to add the measured environment pressure value to a determined pressure drop across muffler.

The environment pressure value is measured, according to the embodiment, by means of the pressure sensor, not shown, associated to an air mass flow sensor of the engine 2. Instead, the determination of the drop of pressure of the exhaust gas across the muffler 4 is performed creating a map, representative of the drop pressure across the muffler 4, in function of the temperature and of the exhaust gas mass flow.

According to the method the pressure value upstream each unit of the after-treatment exhaust system by means of the following equation:

Pᵢ₌Pᵢ₋₁+ΔPᵢ

Where Pᵢ₋₁ is the value of the pressure downstream the unit i and ΔPᵢ is the drop of the pressure across the unit i.

The drop of the pressure ΔPᵢ, across the unit i, is calculated by means of the following equation:

ΔPᵢ=k₁ᵢ·μᵢ·Qᵢ+k₂ᵢ·ρᵢ·Qᵢ²

Where k₁ᵢ and k₂ᵢ are constant, Qᵢ is the gas flow rate, ρᵢ represent the gas density, and μᵢ is the dynamic viscosity of the gas.

According to the embodiment the gas flow rate is determined by the following relationship:

$$Qi = \frac{{\dot{m}}_{AIR} + {\dot{m}}_{ECU}}{{ρ}_{i}}$$

Where \dot{m}_{AIR} is the derivate of the time of the air flow rate aspirated from the engine and \dot{m}_{ECU} is the derivate in the time of the quantity of fuel injected calculated by an ECU of the engine 2, while the gas density ρᵢ is preferably calculated by means of the equation:

$${ρ}_{i} = \frac{{P}_{i - 1}}{{R}_{EG} \cdot {T}_{i - 1}}$$

Where R_{EG} is the universal gas constant and Tᵢ₋₁ is the exhaust gas temperature downstream the unit i.

The dynamic viscosity of the gas μᵢ is calculated by means of the equation:

$${μ}_{i} = {μ}_{i} ( T ) = {μ}_{o} \cdot \frac{{T}_{0} + C}{{T}_{i - 1} + C} \cdot {( \frac{{T}_{i - 1}}{{T}_{0}} )}^{\frac{3}{2}}$$

Where C is the Sutherland's constant for the exhaust gas in question and μ₀ is the reference viscosity at the temperature T₀ and Tᵢ₋₁ is the exhaust gas temperature downstream the unit i.

It is generally undesirable to perform an estimation of the drop of pressure value across the DPF unit 6. As a consequence, the drop of pressure value across the DPF unit 6 is measured by means of the differential pressure sensor 7.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for determining a pressure in an exhaust line associated with an internal combustion engine and which comprises a muffler and an after-treatment system, the after-treatment system comprises a plurality of serially connected units for at least reducing due to combustion products, the method comprising the steps of:
determining a pressure value upstream from the muffler; and
calculating the pressure value upstream from each unit of the plurality of serially connected units based at least partially upon the relationship of:
Pᵢ₌Pᵢ₋₁+ΔPᵢ
wherein Pᵢ₋₁ is a value of the pressure downstream a unit i and ΔPᵢ is a drop of the pressure across the unit i.

2. The method according to claim 1, wherein the determining the pressure value upstream of the muffler comprises
measuring an environment pressure;
creating a map representative of a pressure drop across the muffler as a function of temperature and of an exhaust gas mass flow; and
adding the environment pressure to the pressure drop across the muffler.

3. The method according to claim 1, wherein the drop of the pressure ΔPᵢ, across the unit i, is calculated based at least partially upon the relationship of:
ΔPᵢ=k₁ᵢ·μᵢ·Qᵢ+k₂ᵢ·ρᵢ·Qᵢ²
wherein k₁ᵢ and k₂ᵢ are constant, Qᵢ is a gas flow rate, ρᵢ represent a gas density, and μᵢ is a dynamic viscosity of an exhaust gas.

4. The method according to claim 3, wherein the gas flow rate is calculated based at least partially upon the relationship of:
$$Qi = \frac{{\dot{m}}_{AIR} + {\dot{m}}_{ECU}}{{ρ}_{i}}$$
wherein \dot{m}_{AIR} is a first derivate in time of an air flow rate aspirated from the internal combustion engine and \dot{m}_{ECU} is a second derivate in time of a quantity of fuel injected calculated by an ECU.

5. The method according to claim 3, wherein the gas density ρᵢ is calculated based at least partially upon the relationship of:
$${ρ}_{i} = \frac{{P}_{i - 1}}{{R}_{EG} \cdot {T}_{i - 1}}$$
wherein R_{EG} is the universal gas constant and Tᵢ₋₁ is an exhaust gas temperature downstream the unit i.

6. The method according to claim 3, wherein the dynamic viscosity of the exhaust gas μᵢ is calculated based at least partially upon the relationship of:
$${μ}_{i} = {μ}_{i} ( T ) = {μ}_{o} \cdot \frac{{T}_{0} + C}{{T}_{i - 1} + C} \cdot {( \frac{{T}_{i - 1}}{{T}_{0}} )}^{\frac{3}{2}}$$
wherein C is Sutherland's constant for the exhaust gas in question and μ₀ is a reference viscosity at temperature T₀ and Tᵢ₋₁ is an exhaust gas temperature downstream the unit i.

7. The method according to claim 1, further comprising the step of measuring a DPF pressure drop across a DPF unit.

8. A computer readable medium embodying a computer program product, said computer program product comprising:
a program for determining a pressure in an exhaust line associated with an internal combustion engine and which comprises a muffler and an after-treatment system, the after-treatment system comprises a plurality of serially connected units for at least reducing due to combustion products, the program configured to:
determine a pressure value upstream from the muffler; and
calculate the pressure value upstream from each unit of the plurality of serially connected units based at least partially upon the relationship of:
Pᵢ₌Pᵢ₋₁+ΔPᵢ
wherein Pᵢ₋₁ is a value of the pressure downstream a unit i and ΔPᵢ is a drop of the pressure across the unit i.

9. The computer readable medium embodying the computer program product according to claim 8, wherein the program is further configured to:
measure an environment pressure;
create a map representative of a pressure drop across the muffler as a function of temperature and of an exhaust gas mass flow; and
add the environment pressure to the pressure drop across the muffler.

10. The computer readable medium embodying the computer program product according to claim 8, wherein the drop of the pressure ΔPᵢ, across the unit i, is calculated based at least partially upon the relationship of:
ΔPᵢ=k₁ᵢ·μᵢ·Qᵢ+k₂ᵢ·ρᵢ·Qᵢ²
wherein k₁ᵢ, and k₂ᵢ are constant, Qᵢ is a gas flow rate, ρᵢ represent a gas density, and μᵢ is a dynamic viscosity of an exhaust gas.

11. The computer readable medium embodying the computer program product according to claim 10, wherein the gas flow rate is calculated based at least partially upon the relationship of:
$$Qi = \frac{{\dot{m}}_{AIR} + {\dot{m}}_{ECU}}{{ρ}_{i}}$$
wherein \dot{m}_{AIR} is a first derivate in time of an air flow rate aspirated from the internal combustion engine and \dot{m}_{ECU} is a second derivate in time of a quantity of fuel injected calculated by an ECU.

12. The computer readable medium embodying the computer program product according to claim 10, wherein the gas density ρᵢ is calculated based at least partially upon the relationship of:
$${ρ}_{i} = \frac{{P}_{i - 1}}{{R}_{EG} \cdot {T}_{i - 1}}$$
wherein R_{EG} is the universal gas constant and Tᵢ₋₁ is an exhaust gas temperature downstream the unit i.

13. The computer readable medium embodying the computer program product according to claim 10, wherein the dynamic viscosity of the exhaust gas μᵢ is calculated based at least partially upon the relationship of:
$${μ}_{i} = {μ}_{i} ( T ) = {μ}_{o} \cdot \frac{{T}_{0} + C}{{T}_{i - 1} + C} \cdot {( \frac{{T}_{i - 1}}{{T}_{0}} )}^{\frac{3}{2}}$$
wherein C is Sutherland's constant for the exhaust gas in question and μ₀ is a reference viscosity at temperature T₀ and Tᵢ₋₁ is an exhaust gas temperature downstream the unit i.

14. The computer readable medium embodying the computer program product according to claim 8, further comprising the step of measuring a DPF pressure drop across a DPF unit.

15. An apparatus, comprising:
an exhaust line;
an internal combustion engine associated with the exhaust line;
a muffler for the internal combustion engine;
an after-treatment system comprising a plurality of serially connected units adapted to at least reduce combustion products of the internal combustion engine; and
a controller adapted to:
determine a pressure value upstream from the muffler; and
calculate the pressure value upstream from each unit of the plurality of serially connected units based at least partially upon the relationship of:
Pᵢ₌Pᵢ₋₁+ΔPᵢ
wherein Pᵢ₋₁ is a pressure downstream a unit i and ΔPᵢ is a drop of the pressure across the unit i.

16. The apparatus according to claim 15, wherein the controller is adapted to:
measure an environment pressure;
create a map representative of a pressure drop across the muffler as a function of temperature and of an exhaust gas mass flow; and
add the environment pressure to the pressure drop across the muffler.

17. The apparatus according to claim 15, wherein the drop of the pressure ΔPᵢ, across the unit i, is calculated based at least partially upon the relationship of:
ΔPᵢ=k₁ᵢ·μᵢ·Qᵢ+k₂ᵢ·ρᵢ·Qᵢ²
wherein k₁ᵢ and k₂ᵢ are constant, Qᵢ is a gas flow rate, ρᵢ represent a gas density, and μᵢ is a dynamic viscosity of an exhaust gas.

18. The apparatus according to claim 17, wherein the gas flow rate is calculated based at least partially upon the relationship of:
$$Qi = \frac{{\dot{m}}_{AIR} + {\dot{m}}_{ECU}}{{ρ}_{i}}$$
wherein \dot{m}_{AIR} is a first derivate in time of an air flow rate aspirated from the internal combustion engine and \dot{m}_{ECU} is a second derivate in time of a quantity of fuel injected calculated by an ECU.

19. The apparatus according to claim 17, wherein the gas density ρᵢ is calculated based at least partially upon the relationship of:
$${ρ}_{i} = \frac{{P}_{i - 1}}{{R}_{EG} \cdot {T}_{i - 1}}$$
wherein R_{EG} is the universal gas constant and Tᵢ₋₁ is an exhaust gas temperature downstream the unit i.

20. The apparatus according to claim 17, wherein the dynamic viscosity of the exhaust gas μᵢ is calculated based at least partially upon the relationship of:
$${μ}_{i} = {μ}_{i} ( T ) = {μ}_{o} \cdot \frac{{T}_{0} + C}{{T}_{i - 1} + C} \cdot {( \frac{{T}_{i - 1}}{{T}_{0}} )}^{\frac{3}{2}}$$
wherein C is Sutherland's constant for the exhaust gas in question and μ₀ is a reference viscosity at temperature T₀ and Tᵢ₋₁ is an exhaust gas temperature downstream the unit i.
